(19) United States
(12) Patent Application Publication
(10) Pub. No.: US 2018/0255446 A1
(43) Pub. Date: Sep. 6, 2018

(54) REMOTE ACCESS TO AN ACCESSORY DEVICE

(71) Applicant: Provenance Asset Group LLC, Essex, CT (US)

(72) Inventors: Jukka REUNAMAKI, Tampere (FI); Arto PALIN, Viiala (FI); Teemu SAVOLAINEN, Nokia (FI)

(73) Assignee: Provenance Assest Group LLC, Essex, CT (US)

(21) Appl. No.: 15/756,918

(22) PCT Filed: Sep. 1, 2015
(86) PCT No.: PCT/FI2015/050564

§ 371 Date: Mar. 1, 2018

(51) Int. Cl. H04W 8/00; H04W 76/11; H04L 29/08

(52) U.S. Cl. CPC H04W 8/005; H04L 67/16; H04W 76/11

(57) ABSTRACT

A technique for using a user device to access an accessory device via an intermediate device, which intermediate device is connectable to the accessory device via a wireless link, is provided.

### TECHNICAL FIELD

The example and non-limiting embodiments of the present invention relate to using a user device to access an accessory device via an intermediate device, which intermediate device is connectable to the accessory device via a local wireless link.

### BACKGROUND

Using a local wireless link, such as a Bluetooth BR/EDR link or a Bluetooth Low Energy link, to connect a personal computing device such as a mobile phone, a tablet computer or a laptop computer to an accessory device such as speakers or to a printer has become a standard measure. Such local wireless links are equally applicable for connecting any computing device to accessories of different type, such as sensor devices that provide environmental information, home appliances and even industrial equipment or systems. In particular, the Internet of Things forms a framework that is estimated to introduce a vast number of accessories that are accessible by basically any computing device via a local wireless links.

Typically, updating the functionality of an existing accessory device or introduction of a completely new accessory device also requires updating or installing software in the user's computing device to enable usage of the updated or the new accessory device, which the user may find inconvenient or even difficult. On the other hand, application of the local wireless link limits the use of the accessory device to immediate proximity of the accessory device, while in some cases the at least some of the functions provided by the accessory device might be useful also when the user operates his/her computing device in a remote location.

### SUMMARY

According to an example embodiment, a method is provided, the method comprising receiving, in a first apparatus, from a device over a wireless link, a device identifier associated with the device, transmitting, from the first apparatus over a network to a server device, a device discovery indication to indicate presence of the device, the device discovery indication comprising at least said device identifier, receiving, in the first apparatus, from the server device, communication interface information selected by the server device at least in part in dependence of said device identifier, said communication interface information defining a communication interface for accessing the device via the wireless link, and providing, in the first apparatus, using said communication interface information, a gateway function that enables a second apparatus to access the device via said first apparatus, wherein the first apparatus is able to communicate with the second apparatus over the network.

According to another example embodiment, a method is provided, the method comprising receiving, in a first apparatus, from a server device, user interface information selected by the server device, which user interface information defines a user interface for accessing, over a network, a communication interface provided in a second apparatus that enables access to a device over a wireless link, providing, in the first apparatus, using said user interface information, a user interface to enable a user of the first apparatus to perform a user function of accessing the device via the communication interface provided in the second apparatus, and transferring, over the network, device information between the user interface provided in the first apparatus and the communication interface provided in the second apparatus.

According to another example embodiment, a method is provided, the method comprising receiving, in a server device, from a first apparatus, a device discovery indication that indicates presence of a device, the device indication comprising at least a device identifier associated with the device, transmitting, from the server device to the first apparatus, communication interface information selected by the server device at least in part in dependence of said device identifier, said communication interface information including at least information that defines a communication interface for accessing the device via a wireless link, and transmitting, from the server device to a second apparatus, user interface information selected by the server device at least in part in dependence of said device identifier, said user interface information including at least information that defines a user interface for accessing, over a network, the communication interface provided in the first apparatus.

According to another example embodiment, an apparatus is provided, the apparatus comprising a communication portion comprising at least, a first communication apparatus for wireless communication with other apparatuses over a wireless link, and a second communication apparatus for one of wired and wireless communication with other apparatuses over a network, and a control portion arranged to receive, from a device, using said first communication apparatus, a device identifier associated with the device, transmit, to a server device, using said second communication apparatus, a device discovery indication to indicate presence of the device, the device discovery indication comprising at least said device identifier, receive, from the server, using said second communication apparatus, communication interface information selected by the server device at least in part in dependence of said device identifier, said communication interface information defining a communication interface for accessing the device using said first communication apparatus, and provide, using said communication interface information, a gateway function that enables a second apparatus to access the device via the apparatus, wherein the control portion is arranged to communicate with the second apparatus using the second communication apparatus.

According to another example embodiment, an apparatus is provided, the apparatus comprising a communication portion comprising at least a communication apparatus for one of wired and wireless communication with other apparatuses over a network, and a control portion arranged to receive, from a server device, using said communication apparatus, user interface information selected by the server device, which user interface information defines a user interface for accessing, using said communication apparatus, a communication interface provided in a second apparatus that enables access to a device over a wireless link, provide, using said user interface information, a user interface to enable a user of the apparatus to perform a user function of accessing the device via the communication interface provided in the second apparatus, and transfer, using said communication apparatus, device information between the user interface provided in the apparatus and the communication interface provided in the second apparatus.

According to another example embodiment, an apparatus is provided, the apparatus comprising a communication portion comprising at least a communication apparatus for one of wired and wireless communication with other apparatuses over a network, and a control portion arranged to use the communication apparatus to receive, from a first apparatus, a device discovery indication that indicates presence of a device, the device indication comprising at least a device identifier associated with the device, transmit, to the first apparatus, communication interface information selected in the apparatus at least in part in dependence of said device identifier, said communication interface information including at least information that defines a communication interface for accessing the device via a wireless link, and transmit, to a second apparatus, user interface information selected in the apparatus at least in part in dependence of said device identifier, said user interface information including at least information that defines a user interface for accessing, over a network, the communication interface provided in the first apparatus.

According to another example embodiment, an apparatus is provided, the apparatus comprising means for receiving, from a device, over a wireless link, a device identifier associated with the device, means for transmitting, over a network to a server device, a device discovery indication to indicate presence of the device, the device discovery indication comprising at least said device identifier, means for receiving, from the server device, communication interface information selected by the server device at least in part in dependence of said device identifier, said communication interface information defining a communication interface for accessing the device via the wireless link, and means for providing, in the apparatus, using said communication interface information, a gateway function that enables a second apparatus to access the device via the apparatus, wherein the apparatus is able to communicate with the second apparatus over the network.

According to another example embodiment, an apparatus is provided, the apparatus comprising means for receiving, from a server device, user interface information selected by the server device, which user interface information defines a user interface for accessing, over a network, a communication interface provided in a second apparatus that enables access to a device over a wireless link, means for providing, in the apparatus, using said user interface information, a user interface to enable a user of the apparatus to perform a user function of accessing the device via the communication interface provided in the second apparatus, and means for transferring, over the network, device information between the user interface provided in the apparatus and the communication interface provided in the second apparatus.

According to another example embodiment, an apparatus is provided, the apparatus comprising means for receiving, from a first apparatus, a device discovery indication that indicates presence of a device, the device indication comprising at least a device identifier associated with the device, means for transmitting, to the first apparatus, communication interface information selected in the apparatus at least in part in dependence of said device identifier, said communication interface information including at least information that defines a communication interface for accessing the device via a wireless link, and means for transmitting, to a second apparatus, user interface information selected in the apparatus at least in part in dependence of said device identifier, said user interface information including at least information that defines a user interface for accessing, over a network, the communication interface provided in the first apparatus.

According to another example embodiment, a computer program is provided, the computer program comprising computer readable program code configured to cause performing at least one of the methods according to the example embodiments described in the foregoing when said program code is executed on a computing apparatus:

The computer program according to an example embodiment may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to an example embodiment of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 schematically illustrates some components of a wireless communication arrangement according to an example embodiment;

FIG. 2 schematically illustrates some components of an accessory device according to an example embodiment;

FIG. 3 schematically illustrates some components of a gateway device according to an example embodiment;

FIG. 4 schematically illustrates some components of a terminal device according to an example embodiment;

FIG. 5 schematically illustrates some components of a server device according to an example embodiment;

FIG. 6 depicts signaling between elements of the wireless communication arrangement according to an example embodiment.

FIG. 7 illustrates a method according to an example embodiment;

FIG. 8 illustrates a method according to an example embodiment; and

FIG. 9 illustrates a method according to an example embodiment.

### DESCRIPTION OF SOME EMBODIMENTS

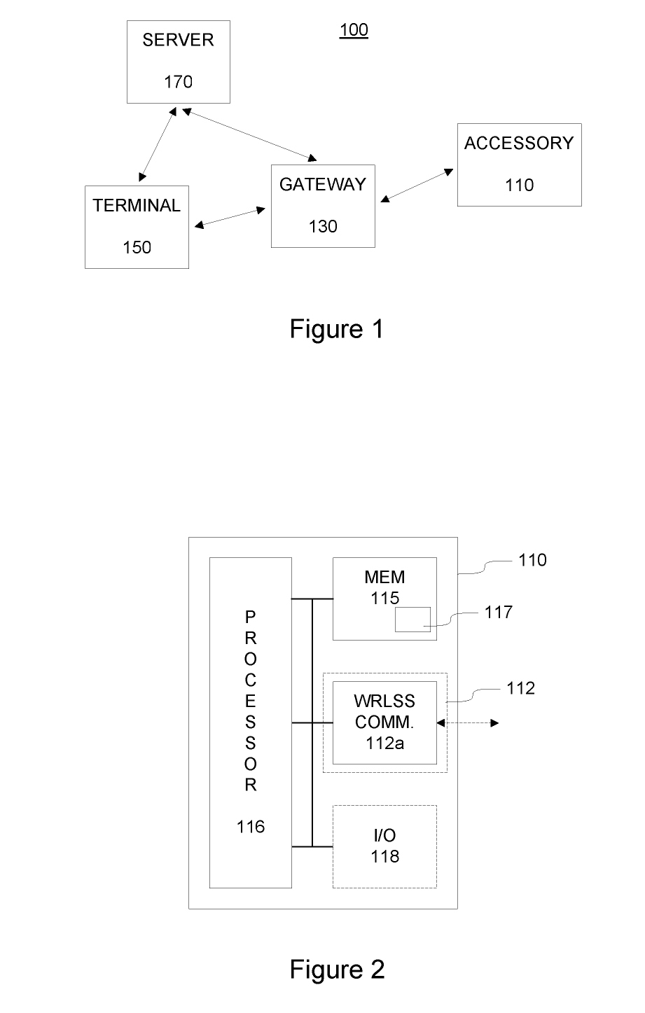

FIG. 1 schematically illustrates some components and/or entities of a wireless communication arrangement 100 to depict an exemplifying framework for one or more embodiments of the present invention. The wireless communication arrangement 100 comprises an accessory device 110, a gateway device 130, a terminal device 150 and a server device 170.

The accessory device 110 is typically a special-purpose device that may be arranged to provide access to information and/or to a service. As examples regarding access to information and/or service, the accessory device 110 may provide e.g. an interface for obtaining information from the accessory device 110 or from a device coupled thereto, an interface for transferring information to the accessory device 110 or to a device coupled thereto, and/or an interface for controlling operation of the accessory device 110 or operation of a device coupled thereto. The information available via the accessory device 110 may include pre-stored static information, which may pertain e.g. to the accessory device 110 itself or to other aspects or services in vicinity of the accessory device 110 (such as positioning data, network connectivity in vicinity, etc.). As another example the accessory device 110 may provide access to dynamically updated information, e.g. environmental information obtained from a sensor that may be included in or coupled to the accessory device 110, which sensor may be arranged to measure an environmental characteristic such as ambient temperature, air pressure, air humidity, CO₂ level, a level of ambient light. As another example of dynamically updated information, sensory information that is indicative of vital signs of a person or an animal, such as temperature, pulse, respiratory rate, blood pressure, oxygen saturation, etc. may be obtained. As a variation of these examples, the sensor may be a microphone arranged to capture respective audio signals representing sounds in vicinity of the accessory device 110 or an image sensor arranged to capture respective image or video signals depicting respective view(s) in vicinity of the accessory device 110. As a further example, the accessory device 110 may include or be coupled to a display for rendering a video signal or other information transferred from a device using the accessory device 110 or the accessory device 110 may include or be coupled to a speaker for playing back an audio signal provided from a device using the accessory device 110. As a further example, the accessory device 110 may include or be coupled to an actuator that enables controlling a service and/or a further device. Examples of such services or further devices include lighting arrangements, heating systems, home appliances (such as washing machines, fridges, coffee makers, etc.), industrial machinery or industrial systems (such as AC drives, air conditioning systems, pumps, valves, escalators, heat pumps, engines, street lamps, switches, fuse boards, fire alarms systems, etc.). As a specific example, the accessory device 110 may be a device that belongs to the Internet of Things (IoT), i.e. an IoT device. However, the exact characteristics of the information and/or service available in the accessory device 110 are not material to the embodiments of the present invention, as will become apparent on basis of the following description.

According to an example, the accessory device 110, the gateway device 130 and the terminal device 150 are devices owned and/or used by the same user. According to another example, the accessory device 110 and the terminal device 150 may owned/used by the same user, whereas the gateway device 130 is a ‘shared’ device that may by employed by a multiple pairs of the accessory device 110 and the terminal device 150. As a further example, the accessory device 110 and the gateway device 130 may be ‘shared’ devices that may be used by terminal devices 150 of a plurality of users. The gateway device 130 may be a semi-stationary device, i.e. a device that is basically a portable device but that is not typically moved from its location, that is only infrequently relocated from one place to another and/or that is used within a restricted geographical area (such as an office or home), whereas the terminal device 150 may be a mobile device that is typically frequently carried by the user. As a few examples, the gateway device 130 may be a desktop computer, a laptop computer, a tablet computer, a fixed router, a mobile router, a base station of a cellular system (e.g. such as a microcell, a picocell or a femtocell), etc., whereas the terminal device 150 may be a mobile phone, a smartphone, a portable gaming device, a portable music player or media player, a portable navigation device, a personal digital assistant (PDA), a tablet computer, etc.

The server device 170 is typically a remote server device that is arranged to provide a server function that is accessible by a number of users. In particular, a given user may access the server function available in the server device 170 using the gateway device 130 and/or the terminal device 150. Although described herein, for editorial clarity of description, as a single entity, the server function described herein by using the server device 170 as an example may be jointly provided by a number of server devices that are arranged to provide a cloud service or a cloud server arrangement.

The components of the wireless communication arrangement 100 depicted in FIG. 1 provide a non-limiting example that depicts a single accessory device 110, a single gateway device 130 and a single terminal device 150 for improved clarity of illustration and for improved clarity and brevity of description. However, in general the wireless communication arrangement 100 may comprise one or more accessory devices 110, one or more gateway devices 130 and one or more terminal devices 150.

FIG. 2 schematically illustrates some components of an exemplifying accessory device 110. The accessory device 110 may comprise further components or portions in addition to those depicted in FIG. 2, whereas the ones depicted therein are ones that are considered relevant for description of some embodiments of the present invention. The accessory device 110 comprises a communication portion 112 for wireless and/or wired communication with other devices. The communication portion 112 comprises at least a wireless communication apparatus 112a, whereas the communication portion 112 may comprise one or more further (wireless and/or wired) communication apparatuses. The wireless communication apparatus 112a may enable, for example, wireless communication with other devices by using a wireless communication technique or protocol that enables a point-to-point or a point-to-multipoint wireless connection with another device. The accessory device 110 is hence capable of communicating with other devices that are equipped with a wireless communication apparatus using the same technique/protocol, e.g. with the gateway device 130.

The accessory device 110 further comprises a processor 116 and a memory 115 for storing data and computer program code 117. The accessory device 110 may further comprise user I/O (input/output) components 118 that may be arranged, possibly together with the processor 116 and a portion of the computer program code 117, to provide a user interface for receiving input from a user of the first device 110 and/or providing output to the user of the accessory device 110. The user I/O components 118 may comprise hardware components such as a display, a touchscreen, a touchpad, a mouse, a keyboard, and/or an arrangement of one or more keys or buttons, etc. The processor 116 may be arranged to control operation of the accessory device 110 e.g. in accordance with a portion of the computer program code 117 stored in the memory 115 and possibly further in accordance with the user input received via the user I/O components 118 and/or in accordance with information received via the communication portion 112. The memory 115 and a portion of the computer program code 117 stored therein may be further arranged to, with the processor 116, to provide a control portion or a control function for controlling operation of a communication apparatus of the communication portion 112, possibly together with a control portion or a control function that may be provided within the respective communication apparatus of the communication portion 112 (which will be described later in this text). These control functions may be, separately or jointly, referred to as control means (of the accessory device 110).

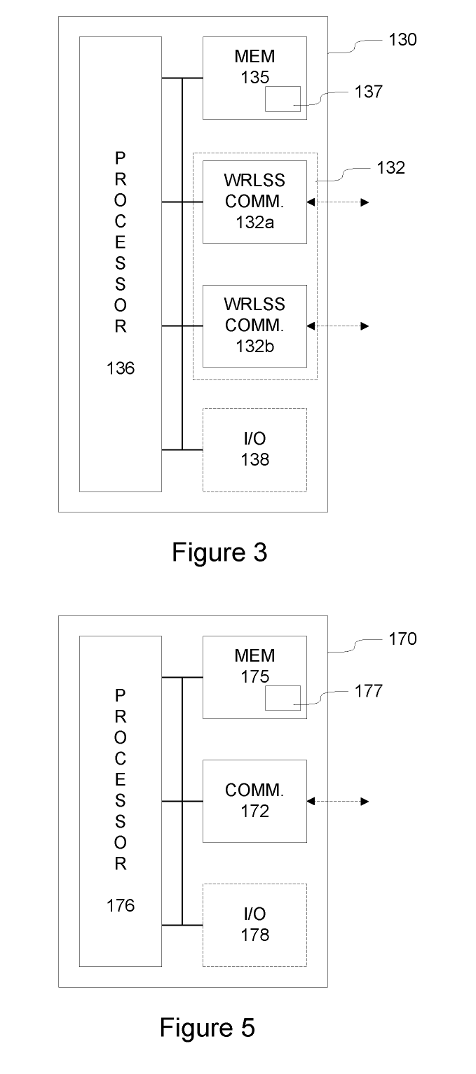

FIG. 3 schematically illustrates some components of an exemplifying gateway device 130. The gateway device 130 may comprise further components or portions in addition to those depicted in FIG. 3, whereas the ones depicted therein are ones that are considered relevant for description of some embodiments of the present invention. The gateway device 130 comprises a communication portion 132. The communication portion 132 comprises at least a first wireless communication apparatus 132a and a second wireless communication apparatus 132b. The communication portion 132 may comprise one or more further (wireless and/or wired) communication apparatuses. The first wireless communication apparatus 132a is preferably one that enables wireless communication with the wireless communication apparatus 112a, thereby enabling the gateway device to wirelessly communicate with the accessory device 110 and/or with other devices equipped with communication apparatus using the same technique/protocol. The second wireless communication apparatus 132b, in turn, may apply communication technique/protocol different from that of the wireless communication apparatus 132a and it may enable communication with the terminal device 150 and/or with the server device 170.

The gateway device 130 further comprises a processor 136 and a memory 135 for storing data and computer program code 137. The gateway device 130 may further comprise user I/O (input/output) components 138 that may be arranged, together with the processor 136 and a portion of the computer program code 137, to provide a user s interface for receiving input from a user of the gateway device 130 and/or providing output to the user of the gateway device 130. The user I/O components 138 may comprise hardware components such as a display, a touchscreen, a touchpad, a mouse, a keyboard and/or an arrangement of one or more keys or buttons, etc. The processor 136 may be arranged to control operation of the gateway device 130 in accordance with a portion of the computer program code 137 stored in the memory 135 and possibly further in accordance with the user input received via the user I/O components 138 and/or in accordance with information received via the communication portion 132. The memory 135 and a portion of the computer program code 137 stored therein may be further arranged, with the processor 136, to provide a control portion or a control function for controlling operation of a communication apparatus of the communication portion 132, possibly together with a control portion or a control function that may be provided within the respective communication apparatus of the communication portion 132 (which will be described later in this text). These control functions may be, separately or jointly, referred to as control means (of the gateway device 130).

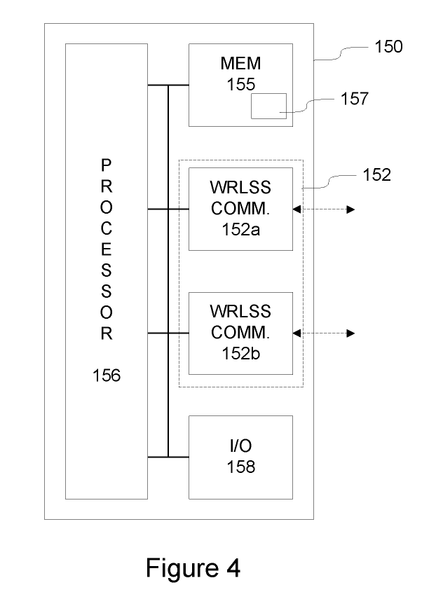

FIG. 4 schematically illustrates some components of an exemplifying terminal device 150. The terminal device 150 may comprise further components or portions in addition to those depicted in FIG. 4, whereas the ones depicted therein are ones that are considered relevant for description of some embodiments of the present invention. The terminal device 150 comprises a communication portion 152. The communication portion 152 comprises at least a wireless communication apparatus 152b. The wireless communication apparatus 152b is preferably one that enables wireless communication with the gateway device 130 and/or with the server device 170. The communication portion 152 may comprise one or more further (wireless and/or wired) communication apparatuses. In particular the communication portion 152 may comprise a wireless communication portion 152a, that enables wireless communication with the wireless communication apparatus 112a of the accessory device 110.

The terminal device 150 further comprises a processor 156 and a memory 155 for storing data and computer program code 157. The terminal device 150 may further comprise user I/O (input/output) components 158 that may be arranged, together with the processor 156 and a portion of the computer program code 157, to provide a user s interface for receiving input from a user of the terminal device 150 and/or providing output to the user of the terminal device 150. The user I/O components 158 may comprise hardware components such as a display, a touchscreen, a touchpad, a mouse, a keyboard and/or an arrangement of one or more keys or buttons, etc. The processor 156 may be arranged to control operation of the terminal device 150 in accordance with a portion of the computer program code 157 stored in the memory 155 and possibly further in accordance with the user input received via the user I/O components 158 and/or in accordance with information received via the communication portion 152. The memory 155 and a portion of the computer program code 157 stored therein may be further arranged, with the processor 156, to provide a control portion or a control function for controlling operation of a communication apparatus of the communication portion 152, possibly together with a control portion or a control function that may be provided within the respective communication apparatus of the communication portion 152 (which will be described later in this text). These control functions may be, separately or jointly, referred to as control means (of the terminal device 150).

FIG. 5 schematically illustrates some components of an exemplifying server device 170. The server device 170 may comprise further components or portions in addition to those depicted in FIG. 5, whereas the ones depicted therein are ones that are considered relevant for description of some embodiments of the present invention. The server device 170 comprises a communication portion 172. The communication portion 172 comprises one or more wireless or wired communication apparatuses that enable communication with the gateway device 130 and/or with the terminal device 150.

The server device 170 further comprises a processor 176 and a memory 175 for storing data and computer program code 177. The server device 170 may further comprise user I/O (input/output) components 178 that may be arranged, together with the processor 176 and a portion of the computer program code 177, to provide a user interface for receiving input from a user of the server device 170 and/or providing output to the user of the server device 170. The user I/O components 178 may comprise hardware components such as a display, a touchscreen, a touchpad, a mouse, a keyboard and/or an arrangement of one or more keys or buttons, etc. The processor 176 may be arranged to control operation of the server device 170 in accordance with a portion of the computer program code 177 stored in the memory 175 and possibly further in accordance with the user input received via the user I/O components 178 and/or in accordance with information received via the communication portion 172. The memory 175 and a portion of the computer program code 177 stored therein may be further arranged, with the processor 176, to provide a control portion or a control function for controlling operation of a communication apparatus of the communication portion 172, possibly together with a control portion or a control function that may be provided within the respective communication apparatus of the communication portion 172 (which will be described later in this text). These control functions may be, separately or jointly, referred to as control means (of the server device 170).

In the foregoing, the description refers to (wireless or wired) communication apparatuses of the communication portions 112, 132, 152 and 172. Any of these communication apparatuses may be also considered as a respective communication means.

As described in the foregoing, the communication portions 112, 132, 152, 172 may comprise e.g. wireless communication apparatuses 112a, 132a, 132b, 152a and 152b, where a wireless communication apparatus 112a, 132a, 132b, 152a, 152b may be also referred to as a respective wireless communication means. A wireless communication apparatus may be provided e.g. as a respective chipset and/or as a respective communication module. For clarity and brevity of description, each of the wireless communication apparatuses 112a, 132a, 132b, 152a and 152b may be considered as a respective single logical entity that may also be capable of processing at least some of the information received via the wireless link and/or at least some of the information that is to be transmitted via the wireless link without external control from other components of the respective device 110, 130, 150, 170 (e.g. from the processor 116, 136, 156, 176, respectively). In an embodiment, a wireless communication apparatus 112a, 132a, 132b, 152a, 152b comprises e.g. a respective wireless transceiver portion for wireless communication and a respective control portion (or a control function) for controlling operation of the respective wireless transceiver portion and for processing information received/transmitted via the respective wireless transceiver portion. Such a control function may be provided by hardware means, by software means or by a combination of hardware means and software means. As an example in this regard, the wireless communication apparatus may comprise a memory, a processor and a portion of a computer program code stored in the memory may be arranged to, with the processor, provide the control function for controlling operation of the respective wireless communication apparatus 112a, 132a, 132b, 152a, 152b, either independently or jointly with the control function provided by the respective memory 115, 135, 155, 175, a portion of the respective computer program 117, 137, 157, 177 and the respective processor 116, 136, 156, 176 of the respective device 110, 130, 150, 170.

The wireless link between the wireless communication apparatus 112a of the communication portion 112 and the wireless communication apparatus 132a of the communication portion 132 (or between the wireless communication apparatuses 112a and 152a or 132a and 152a) may be provided by employing a suitable short-range wireless communication technique or protocol. Such a wireless link may also be referred to as a local wireless link. The term short-range wireless communication as used herein refers to a wireless communication technique or protocol that enables typical operating range in the scale of tens of meters, e.g. up to 100 meters. However, especially in an indoor environment, the operating range of such short-range wireless communication technique/protocol may be significantly shorter e.g. due to walls and other stationary structures as well as furniture etc. that are likely to partially block or interfere with the radio communication between wireless communication portions 112a, 132a (or between wireless communication apparatuses 112a and 152a or 132a and 152a). On the other hand, in favorable conditions in outdoor use the operating range may extend to several hundreds of meters.

Examples of such a wireless technique/protocol include the Bluetooth Basic Rate/Enhanced Data Rate (BT BR/EDR) protocol and the Bluetooth Low Energy (BLE) protocol, both specified e.g. in the Bluetooth Specification Version 4.1, Covered Core Package version: 4.1 (publication date 3 Dec. 2013), incorporated herein by reference in its entirety. In the following, this document is referred to as a Bluetooth Specification. However, the BT BR/EDR and BLE technologies serve as illustrative and non-limiting examples in this regard, and the description generalizes into any short-range wireless communication technique/protocol.

The wireless communication apparatus 132b in the communication portion 132 of the gateway device 130 may be arranged to employ any suitable wireless access technology known in the art to establish a connection to a computer network that further connects the gateway device 130 to the terminal device 150 and/or to the server device 170. As an example in this regard, the wireless communication apparatus 132b may be arranged to employ a wireless local area networking technology such as Wireless Local Area Network (WLAN) technology specified e.g. in IEEE 802.11 specifications (where the acronym IEEE stands for the Institute of Electrical and Electronics Engineers) to establish a wireless link with a wireless access point in its vicinity, which wireless link enables the gateway device 130 to access a computer network that further enables connection to the terminal device 150 and/or to the server device 170. As another example, the wireless communication apparatus 132b may be arranged to employ a cellular access technology known in the art to establish a wireless link with a base station of a cellular network, which wireless link enables the gateway device 130 to access a computer network that further enables connection to the terminal device 150 and/or to the server device 170. Similar considerations with respect to the wireless access technologies employed for establishing a wireless connection with a computer network that further enables connection to other devices are applicable to the wireless communication apparatus 152b of the communication portion 152 of the terminal device 150 or any possible wireless communication apparatuses of the communication portion 172 of the server device 170 as well.

In the following, this text may simply refer to a device 110, 130, 150, 170 carrying out a certain operation (e.g. receiving and/or transmitting certain information and/or message(s)) when describing the act of a communication apparatus of the respective communication portion 112, 132, 152, 172 carrying out said certain operation under control of the respective control portion, control function or control means. In particular,
transfer of information or messages between the accessory device 110 and the gateway device 130 is carried out via the wireless communication apparatuses 112a and 132a, unless explicitly stated otherwise;
transfer of information or messages between the gateway device 130 and the terminal device 150 is carried out via the wireless communication apparatuses 132b and 152b, unless explicitly stated otherwise;
transfer of information or messages between the gateway device 130 and the server device 170 is carried out via the wireless communication apparatus 132b, unless explicitly stated otherwise; and
transfer of information or messages between the terminal device 150 and the server device 170 is carried out via the wireless communication apparatus 152b, unless explicitly stated otherwise.

This approach is believed to improve editorial clarity and readability of the text, while the technical meaning of such expressions remains clear.

Instead of using the wireless access provided by the wireless communication apparatus 132b, the communication portion 130 of the gateway device 130 may be arranged to use a further communication apparatus of the communication portion 130 that employs a suitable wired technology known in the art, such as the Ethernet, in communicating with the computer network that further connects it to the server device 170 and/or to the terminal device 150. In such a scenario the communication portion 130 may or may not include the second wireless communication apparatus 132b. Similarly, instead of relying on wireless access, the communication portion 150 of the terminal device 150 may be arranged to use a further communication apparatus of the communication portion 150 that employs a suitable wired technology known in the art, such as the Ethernet, in communicating with the computer network that further connects it to the server device 170 and/or to the gateway device 130. In such a scenario the communication portion 150 may or may not include the second wireless communication apparatus 152b

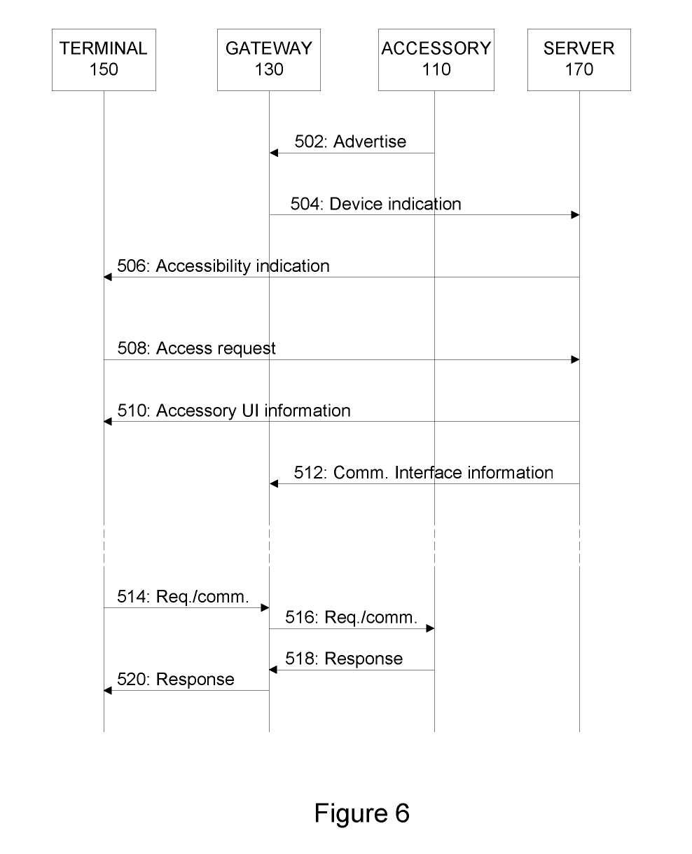

FIG. 6 depicts a signaling chart that serves as an example of operation of the wireless communication arrangement 100 at a high level. In particular, the illustrative and non-limiting example of FIG. 6 shows an outline of communication between the accessory device 110, the gateway device 130, the terminal device 150 and the server device 170 to enable a user of the terminal device 150 to access information or service available in the accessory device 110 and/or to control or adjust operation of the accessory device 110.

In step 502, the accessory device 110 indicates its presence to other devices in its vicinity. In this regard, the accessory device 110 may transmit a device identifier associated therewith, which may be referred to as an accessory device identifier. The accessory device identifier serves to uniquely identify the accessory device 110, and it may comprise e.g. an address, a serial number or other identifier assigned for the accessory device 110 or for the wireless communication portion 112a therein. As an example, an applicable address in this regard may be the device address of the wireless communication portion 112a. The accessory device 110 may further transmit further identifiers together with the accessory device identifier. Such further identifiers may serve as an indication of one or more of the following: a device type identifier that indicates the type of the accessory device 110 (e.g. as a device of one of predetermined device types) and a service type identifier that indicates the type of information or service available in or via the accessory device 110

The accessory device identifier may be provided in one or more messages transmitted from the accessory device 110, which one or more messages at least serve to identify the accessory device and may further serve to carry information related to connection creation and connection establishment with the accessory device 110 and/or to carry information concerning information and/or services available in or via the accessory device 110. Without losing generality, such messages may be referred to as device discovery messages. Consequently, other devices may discover the accessory device 110 and possibly also information/services available therein on basis of device discovery messages received from the accessory device 110. Device discovery messages may comprise advertising messages transmitted from the accessory device 110 on its own initiative (e.g. in accordance with a predefined schedule) or device discovery messages may comprise response messages transmitted from the accessory device 110 in response to a request received from the gateway device 130.

The accessory device 110 and the gateway device 130 may be configured to communicate with each other using any suitable type of wireless transmission/reception technology. Suitable types of technology include, but are not limited to BT BR/EDR and BLE. Other non-limiting examples of suitable technologies in this regard include wireless communication technologies based on WLAN IEEE 802.11 and IEEE 802.15.4. Protocols used in communication between the accessory device 110 and the gateway device 130 may include, for example, one or more of the following: the Internet Protocol (IP), the Internet Protocol version 6 (IPv6), the Bluetooth Generic Attribute Profile (GATT), the Constrained Application Protocol (CoAP), the Hypertext Transfer Protocol (HTTP), the HTTP/2, the MQ Telemetry Transport (MQTT), the Advanced Message Queueing Protocol (AMQP).

In step 504, the gateway device 130 transmits a device discovery indication to the server device 170. The indication is transmitted in response to discovering, e.g. detecting the presence of, the accessory device 110. As an example, the gateway device 130 may consider the accessory device 110 to be discovered in response to receiving at least one (or another predetermined number) of device discovery messages within a predefined time period. In another example, the gateway device 130 may consider the accessory device 110 to be discovered in response to detecting the accessory device to be sufficiently close to the gateway device 130. In this regard, the gateway device 130 may compute a received signal strength indication (RSSI) on basis of respective signals that carried one or more received device discovery messages and detect based on the computed RSSI whether the accessory device 110 is in close proximity to the gateway device 130. As an example, the detection may comprise detecting the accessory device 110 to be in close proximity in response to the computed RSSI exceeding a predetermined threshold value and detecting the accessory device 110 to not be in close proximity in response to the RSSI not reaching the predetermined threshold value.

The device discovery indication may be transferred in one or more messages transmitted from the gateway device 130 to the server device 170. The device discovery indication comprises at least the accessory device identifier of the detected accessory device 110 and a device identifier associated with the gateway device 130. The device identifier associated with the gateway device 130 may be referred to as a gateway device identifier, and it may e.g. serve as information that enables the server device 170 to identify the gateway device 130 and/or to detect the type of the gateway device 130. The gateway device identifier may comprise a device identifier that uniquely identifies the gateway device 130, such as a device address, a serial number or other identifier assigned for the gateway device 130 or for the wireless communication apparatus 132b therein. As an example, an applicable address in this regard may comprise the device address of the wireless communication portion 132a, the device address of the wireless communication portion 132b or an IP address assigned for the gateway device 130. The gateway device identifier may be employed in the server device 170 to identify one or more terminal devices associated to the gateway device 130.

The device discovery indication may further comprise e.g. a user identifier associated with the current user of the gateway device 130. The user identifier may comprise a username, an email address, a telephone number or other suitable identifier assigned for the current user of the gateway device 130. The user identifier may be used in the server device 170 as further information in identifying one or more terminal devices associated to the gateway device 130.

The gateway device 130 may be configured to connect the computer network that interconnects it to the server device 170 and/or to the terminal device 150 using any suitable type of wireless or wired transmission/reception technology known in the art. The connection between the gateway device 130 and another device (e.g. the terminal device 150 or the server device 170) may involve several different types of communication technologies or they may be connected by using a single communication technology. Suitable types of communication technology employed by the gateway device 130 to connect to the computer network include, but are not limited to WLAN IEEE 802.11, various cellular technologies known in the art and wired technologies such as the Ethernet. Suitable types of communication technology used by the server device 170 include, but are not limited to wired technologies such as the Ethernet. Further examples of technologies suitable for carrying messages between the server device 170 and the gateway device 130 include a coaxial cable and an optical fiber. Protocols used in communication between the gateway 130 and server 170 may include, for example, IP, IPv6, CoAP, HTTP, HTTP/2, MQTT, AMQP, or a like.

The server device 170 may store (e.g. stored in the memory 175) a user device database that includes a plurality of database entries. According to an example, each s of the database entries includes at least a gateway device identifier and one or more terminal device identifiers associated therewith, the user device database thereby providing a mapping between a gateway device and terminal device(s) associated therewith for a plurality of gateway devices. A terminal device identifier serves to uniquely identify a respective terminal device 150 assigned to the respective user and to the respective gateway device 130. The terminal device identifier may comprise e.g. an address, a serial number or other identifier assigned for the respective terminal device 150 or for the wireless communication portion 152b therein. As an example, an applicable address in this regard may comprise the device address of the wireless communication portion 152b or an IP address assigned for the terminal device 150.

Upon receiving the device discovery indication from the gateway device 130, the server device 170 may access the user device information database in order to identify one or more terminal devices 150 associated with the gateway device identifier received in the device discovery indication. In accessing the user device information database, the server device 170 may search the database entries to find a database entry that includes the gateway device identifier received in the device discovery indication from the gateway device 130, which found database entry includes terminal device identifier(s) that identify the terminal device(s) 150 associated with the gateway device of interest. When/if the database entry corresponding to the received gateway device identifier has been found, the server device 170 may further store the accessory device identifier (e.g. as an additional entry of the identified database entry to the user device information database) to indicate that the respective accessory device 110 is accessible via the gateway device 130.

In another example, instead of providing mapping between a gateway device and terminal device(s) associated therewith, each database entry of the user device database may provide a mapping between an accessory device identifier and one or more terminal device identifiers associated therewith, the user device database thereby providing a mapping between an accessory device and terminal device(s) associated therewith for a plurality of accessory devices. In this example the server device 170 accessing the user device database involves searching for a database entry that includes the accessory device identifier received in the device discovery indication, which found database entry hence includes terminal device identifier(s) that identify the terminal device(s) associated with the accessory device of interest. In this example, when/if the database entry corresponding to the received accessory device identifier has been found, the server device 170 may further store the gateway device identifier (e.g. as an additional entry of the identified database entry to the user device information database) to indicate that the respective accessory device 110 is accessible via the gateway device 130.

The user device information database may further store, in at least some of the database entries, a user identifier associated therewith. Consequently, in case the device discovery indication received from the includes the user identifier that identifies the current user of the gateway device 130, the database search described in the foregoing may be carried in order to find a database entry that includes both the gateway device identifier or the accessory device identifier and the user identifier received in the device discovery indication from the gateway device 130.

In step 506, the server device 170 transmits a device discovery indication concerning the accessory device 110 being accessible via the gateway device 130 to at least one of the terminal device identified in the database search. This device discovery indication may be referred to as accessibility indication. The accessibility indication may be transferred in one or more messages transmitted from the server device 170 to the terminal device 150. In the following, it is assumed that the accessibility indication is transmitted at least to the terminal device 150. According to an example, the server device 170 transmits the accessibility indication to the terminal device 150 automatically in response to the device discovery indication received from the gateway device 110. The accessibility indication comprises the accessory device identifier of the respective accessory device 110 and the gateway device identifier of the gateway device 130, and it may further comprise information that characterizes the accessory device 110 identified in the accessibility indication and/or services or information available therefrom. This characterizing information may include, for example, an indication of the type of the accessory device 110 and/or information concerning services and/or information available in or via the accessory device 110.

According to another example, the server device 170 may transmit the accessibility indication in response to the terminal device 150 requesting information concerning accessory devices that are currently accessible via the gateway device 130. In this approach the server 170 may send a separate accessibility indication for each accessory device that is currently accessible via the gateway device 130.

In this regard, the server device 170 may store (e.g. in the memory 175) an accessory device information database that includes a plurality of database entries. According to an example, each of the database entries may include one or more of the following information elements:
an accessory device identifier that uniquely identifies the respective accessory device;
a type identifier that identifies the type of the respective accessory device of the accessory device;
information concerning the services and/or information available in or via the respective accessory device;
communication interface information that defines a communication interface for accessing the respective accessory device; and
accessory user interface information (accessory UI information) for accessing the respective accessory device using the corresponding communication interface, which accessory UI information defines at least one accessory user interface component (accessory UI component) component for one or more types of terminal devices;
access control list containing information that identifies one or more users who are allowed to access the respective accessory device, wherein the access control list may be provided e.g. as a list of user identifiers.

Hence, among other things, the accessory UI information stored in the accessory device information database defines at least one dedicated user interface component for each considered accessory device to enable convenient user access to the information or service available in the respective accessory device. Moreover, the accessory UI information stored in the accessory device information database may further define, for each considered accessory device, a dedicated version of the user interface component for a number of terminal device types. As an example, this aspect may be employed by defining different user interface components for accessing the same accessory device e.g. by a handheld mobile device (such as a mobile phone, a smartphone, a tablet computer, etc.) that typically have a relatively small display screen and limited user input capabilities and by portable computers (such as laptop computers) that typically have a larger display and more versatile user input capabilities. The terminal device 150 may provide the accessory UI component as part of the user interface provided in the terminal device 150 to enable the user to access the information or service available in the respective accessory device 110.

Upon composing an accessibility indication, the server device 170 may search the accessory device information database in order to find the information that characterizes the accessory device 110 identified in the accessibility indication, e.g. the indication of the type of the accessory device 110 and/or the information concerning services and/or information available in or via the accessory device 110.

In step 508, the terminal device 150 transmits, in response to the accessibility request, an access request to the server device 170 in order to initiate a procedure that enables the terminal device 150 to access the information and/or service available in the accessory device 110 via the gateway device 130. The access request may be transferred in one or more messages transmitted from the terminal device 150 to the server device 170. The access request comprises at least the terminal device identifier (i.e. a device identifier assigned for the terminal device 150) to identify the terminal device transmitting the access request and the accessory device identifier that identifies the accessory device of interest (received e.g. in an accessibility indication from the server device 170).

The terminal device 150 may be configured to connect the computer network that interconnects it to the server device 170 and/or to the gateway device 130 using any suitable type of wireless or wired transmission/reception technology known in the art. The connection between the terminal device 150 and another device (e.g. the gateway device 130 or the server device 170) may several different types of communication technologies or they may be connected by using a single communication technology. Suitable types of communication technology employed by the terminal device 150 include, but are not limited to WLAN IEEE 802.11, various cellular technologies known in the art and wired technologies such as the Ethernet. Suitable types of communication technology used by the server device 170 include, but are not limited to wired technologies such as the Ethernet. Other examples of technologies suitable for carrying messages between the server device 170 and the terminal device 150 include a coaxial cable and an optical fiber. Protocols used in communication between the server device 170 and the terminal device 150 may include, for example, IP, IPv6, CoAP, HTTP, HTTP/2, MQTT, AMQP, or a like.

The access request may further comprise a device type identifier assigned for the terminal device 150, which may serve as input to enable the server device 170 to select appropriate UI information for subsequent provision to the terminal device 150. Alternatively, the server device 170 may store (e.g. in the memory 175) device type mapping database that defines the device type on basis of a device identifier and the server device 170 may use the device type mapping database to determine the device type of the terminal device 150 on basis of the terminal device identifier received from the terminal device 150 in the access request.

The access request may further comprise a user identifier that serves to identify the current user of the terminal device 150. The server device 170 may use the user identifier received in the access request in selecting the appropriate UI information for the terminal device 150.

The access request may further comprise a position indication that indicates the current geographical position of the terminal device 150. As an example in this regard, the terminal device 150 may comprise positioning means (such a receiver of a satellite positioning system) and the position indication may comprise coordinates (e.g. latitude and longitude) that define the current geographical position of the terminal device 150. The terminal device 150 may subsequently periodically (e.g. at regular intervals) transmit an indication of its current position to the server device 170 to enable the server device 170 to facilitate keeping track of the position of the terminal device 150 after the access to the accessory device 110 via the gateway device 130 has been set up. The server device 170 may make use of the position information e.g. in selection of the user interface information to be transmitted to the terminal device 150, as will be described later in this text in more detail.

The transmission of the access request may be triggered in response to a request by a user of the terminal device 150 or the transmission of the access request may be triggered automatically in dependence of the information received in the accessibility indication. For the former scenario, the terminal device 150 may compose an indication concerning the identity of the accessory device 110, the type of the accessory device 110 and/or the service/information available in or via the accessory device 110 on basis of information received in the accessibility indication, provide the composed indication to be displayed to a user via the user interface of the terminal device 150, receive, via its user interface, an indication of a user request to access to the accessory device 110 and transmit the access request in response to the user request. For the latter scenario, the terminal device 150 may automatically transmit the access request in response to information received in the accessibility indication. In this regard, the terminal device 150 may be arranged to transmit the access request in response to accessibility indication indicating a predetermined accessory device, in response to the accessibility indication indicating a predetermined type of accessory device and/or in response to the accessibility indication indicating a predetermined type of service/information to be accessible. An indication of a predetermined accessory device of interest may be provided as pre-stored information in the terminal device 150 (e.g. in the memory 155), derived e.g. on basis of earlier selection(s) made by the user, e.g. as the accessory device identifier of an accessory device that has been previously accessed due to a request by the user, whereas an indication of a predetermined type of accessory device of interest or a predetermined type of service/information of interest may be provided as pre-stored information that serves to indicate user preferences with respect to a type of an accessory device or with respect to a type of service/information.

In step 510, the server device 170 responds to the access request from the terminal device 150 by selecting appropriate accessory UI component for the terminal device 150 and by transmitting accessory UI information that defines the selected accessory UI component to the terminal device 150, which accessory UI component may be provided as part of the user interface of the terminal device 150 to enable the user to access the accessory device 110 via the gateway device 130. The accessory UI information may be transferred in one or more messages transmitted from the server device 170 to the terminal device 150. In step 512, the server device 170 further responds to the access request from the terminal device 150 by selecting and transmitting appropriate communication interface information to the gateway device 130, which communication interface information defines a communication interface or a communication function that enables the terminal device 150 to access the service or information available in the accessory device 110 via the gateway device 130. In particular, a user of the terminal device 150 may use the accessory UI component provided in the terminal device 150 on basis of the accessory UI information received from the server device 170 to perform a user action of accessing the accessory device 110 via the communication interface provided in the gateway device 130 on basis of the communication interface information received from the server device 170. The communication interface information may be transferred in one or more messages transmitted from the server device 170 to the gateway device 130.

Such framework of providing the accessory UI information and the communication interface information enables accessing the accessory device 110 from the terminal device 150 via the gateway device 130 without requiring either of these devices to have any prior knowledge about the accessory device 110 or its characteristics. Consequently, such framework allows a flexible way of introducing new accessory devices in use within the framework of the communication arrangement 100. Moreover, such framework allows, additionally or alternatively, flexible updates in one of the accessory UI information and the communication interface information without necessarily requiring any changes to the other.

As an example, the accessory UI information may be provided as a set of instructions, such as a script or program code that, when executed by the processor 156 of the terminal device 150, causes provision of a respective accessory UI component via the user interface of the terminal device 150. Typically, the accessory UI component is provided as a graphical user interface (GUI) component via in a GUI that that may constitute a part of the user interface of the terminal device 150. The accessory UI information may define, for example, the appearance and functionality of the accessory UI component. Depending on the type of the accessory device 110, the accessory UI information may define an accessory UI component that provides one or more user input elements that enable the user of the terminal device 150 to input control information via the communication interface provided in the gateway device 130 and/or one or more output elements that enable displaying device data received from the accessory device 110 via the communication interface provided in the gateway device 130.

Herein, the term device data refers to the information available in the accessory device 110 or to information derived by the service available in the accessory device 110, whereas the term control information refers to commands or requests received from the accessory UI component e.g. based on user input, and the control information may comprise a request for a certain piece of information available from the accessory device or a command for controlling or adjusting a characteristic of the accessory device 110. The control information and the device data may be jointly referred to as device information.

In addition to the appearance of the accessory UI component, the accessory UI information may further define one or more user interface procedures (UI procedures) for transferring device information between the accessory UI component and the communication interface. In this regard, the accessory UI information may define e.g. one or more conversion procedures for converting the control information from a format input by the user into a different format that is suitable for provision to the control interface and/or one or more conversion procedures for converting the device data from a format applied in the communication interface into a format that is suitable for presentation to the user via the accessory UI component.

As already briefly described in the foregoing, the server device 170 may select the accessory UI information at least in part in dependence of the information received in the access request from the terminal device 150 and/or in dependence of the accessory device information database described in the foregoing. In particular, the server device 170 selecting the accessory UI information for the terminal device 150 may comprise e.g.
determining the type of the terminal device 150 e.g. directly on basis of the device type information that may be received in the access request or by searching the device type mapping database (described in the foregoing) to determine the device type on basis of the terminal device identifier received in the access request;
searching the accessory device information database to identify a database entry corresponding to the accessory device identifier received in the access request,
searching the accessory UI information in the identified database entry to identify the piece of accessory UI information assigned for the device type represented by the terminal device 150.

As a further example concerning UI selection, the selection of the accessory UI information for the terminal device 150 in the server 170 may further consider the user identifier that may be received in the access request. As an example in this regard, the server device 170 may store (e.g. in the memory 175), for a plurality of accessory device identifiers, a respective user mapping database that assigns each of a number of user identifiers into one of a plurality of (e.g. two or more) user groups. Furthermore, the accessory UI information element in a database entry of the accessory device information database may further separately define the respective accessory UI information for a number of different combinations of the terminal device type and the user group. Hence, the server device 170 may search the user mapping database to identify the user group for the user identified by the user identifier received in the access request and search the accessory device information database to identify and select the accessory UI information that corresponds to the respective combination of the accessory device identifier, the terminal device type and the user group. As an example, in this scenario first accessory UI information may be defined for a first user group and second accessory UI information may be defined for a second group of users, where the first accessory UI information defines an accessory UI component different from that defined by the second accessory UI information.

As a further example concerning UI selection, the selection of the accessory UI information for the terminal device 150 in the server 170 may further consider the position indication that may be received in the access request. As an example, the position indication may be used define whether the terminal device 150 is in close proximity to the accessory device 110, and accessory UI information different from that selected for a terminal device that is in close proximity to the accessory device 110 may be selected for a terminal device that is not in close proximity to the accessory device 110. As an example in this regard, the accessory UI information element in a database entry of the accessory device information database may further separately define first accessory UI information for a terminal device that is in close proximity of the accessory device 110 and second accessory UI information for a terminal device that is not in close proximity of the accessory device 110, where the first accessory UI information defines an accessory UI component different from that defined by the second accessory UI information. In this scenario, the server device 170 hence first determines whether the position indication indicates the terminal device 150 to be in close proximity to the accessory device 110 and selects the accessory UI information accordingly.

The terminal device 150 may be considered to be in close proximity to the accessory device 110 if the position indication indicates that the distance between the two devices is shorter than a predetermined threshold distance. For evaluation of the distance, the server device 170 may have a priori knowledge regarding the position of the accessory device identified by an accessory device identifier. In this regard, a position indication indicating the (known or estimated) position of a given accessory device may be stored e.g. as an additional data element in the database entry of the accessory device information database pertaining to the given accessory device. As an example, such position indication may be received in the device discovery indication originating from the gateway device 130. The gateway device 130, in turn, may obtain the position indication by receiving it from the accessory device 110 or by estimating the position of the accessory device 110 upon receiving one or more device discovery messages from the accessory device 110 (e.g. during the device discovery procedure that initiated the transmission of the respective device discovery indication). As another example, the position of the gateway device 130 may be applied as an estimated position of the accessory device 110. In this regard, the gateway device 130 may comprise positioning means (such a receiver of a satellite positioning system) and the position indication may comprise coordinates (e.g. latitude and longitude) that define the current geographical position of the gateway device 130.

In the above scenarios the relationship between the first accessory UI information and the second accessory UI information may be e.g. one or more of the following:
the accessory UI component defined by the first accessory UI information may enable one or more user functions that are not enabled in the accessory UI component defined by the second accessory UI information;
the accessory UI component defined by the second accessory UI information may enable one or more user functions that are not enabled in the accessory UI component defined by the first accessory UI information;

Hence, the accessory UI component defined by the second accessory UI information may define a limited subset of user functions in comparison to those of the accessory UI component defined by the first accessory UI information or vice versa, or the first accessory UI information and second accessory UI information may define accessory UI components that provide completely different user functions. As an illustrative example, this enables providing more versatile or even completely different accessory UI components for maintenance personnel than for ‘normal’ users of the accessory device 110 (based on the user identification). As another example, this allows enabling certain user functions only when the terminal device 150 (and assumingly also the user thereof) is in close proximity to the accessory device 110, which is likely to result in improved security or safety in controlling accessory devices 110 such as home appliances or industrial machinery (e.g. by enabling initiation of an action or switching on a device via the user interface provided in the terminal device 150 only when the user thereof is assumed to be in close proximity to the controlled accessory device 110).

According to an example, the communication interface information may be provided as a set of instructions, such as a script or program code that, when executed by the processor 136 of the gateway device 130, causes the gateway device 130 to implement a communication interface that enables access to the accessory device 110 via a (local) wireless link, and the gateway device 130 may use the communication interface information to implement a gateway function that enables the terminal device 150, which communicates with the gateway device 130 over the computer network, to have access to the accessory device 110 via the gateway device 130. As another example, the communication interface information may be provided as a configuration or parameters of a predefined framework that cause the predefined framework to provide the communication interface.

The communication interface may provide one or more communication procedures that enable accessing the accessory device 110. As an example, the communication procedures may comprise one or more request procedures that involve transmitting to the accessory device 110 a request to obtain a respective piece of device data therefrom and one or more procedures for receiving the requested device data. As another example, the communication procedures may comprise one or more control procedures that involve transmitting to the accessory device 110 a request or command to change or adjust respective characteristics of operation of the accessory device 110.

The gateway function serves to transfer the device information between the accessory UI component in the terminal device 150 and the accessory device 110. In a most straightforward example, the transfer of device information comprises relaying control information, e.g. a request or command, received from the accessory UI component to a respective communication procedure of the communication interface for delivery to the accessory device 110 and relaying device data received from a respective communication procedure of the communication interface to the accessory UI component. In another example, the communication interface information may further define one or more conversion procedures for converting the control information from a format in which is received from the accessory UI component into a another (different) format that is suitable for provision via the control interface using the communication procedures and/or one or more conversion procedures for converting the device data received from the accessory device 110 from a format applied in the communication interface into another (different) format that is suitable for provision for presentation to the user via the accessory UI component. In such a scenario the transfer of device information comprises applying the respective conversion procedures to convert the device information into one format to another.

In case the server device 170 received the position indication from the terminal device 150 in the access request, it may transmit the position indication to the gateway device 130 together with the communication interface information. Moreover, the server device 170 may subsequently transmit an updated position indication concerning the current position of the terminal device 150 based on updates the server device 170 may receive from the terminal device 150. The gateway device 130 may use the position indication(s) in limiting the access to the accessory device 110, as will be described later in this text in more detail.

The server device 170 may further transmit the terminal device identifier of the terminal device 150 to the gateway device 130 together with the communication interface information. The gateway device 130 may employ the terminal device identifier to recognize the terminal device 150 as a device that is allowed to access the accessory device 110 using the gateway function provided in the gateway device 130 and/or in estimating the position of the terminal device 150 with respect to position of the accessory device 110.

According to an example, the server device 170 may further respond to the access request from the terminal device 150 by transmitting, to the gateway device 130, access credentials that enable accessing the accessory device 110. In this regard, the accessory device database in the server device 170 may further store, for at least some of the database entries, an information element that defines the access credentials required for accessing the respective accessory device, and the server device 170 may search the accessory device information database to find the database entry for the accessory device identified in the access request (received from the terminal device 150) and use the access credentials provided in the found database entry to the gateway device 130. Consequently, before or in the course of providing the gateway function that allows access to the terminal device 150 to access the accessory device 110, the gateway device 130 may carry out an authentication procedure with the accessory device 110 by using the access credentials received from the server device 170 in order to identify itself as a device that is authorized to access the accessory device 110.

According to another example, the server device 170 may further respond to the access request from the terminal device 150 by transmitting the access credentials required to access the accessory device 110 also to the terminal device 150. The terminal device 150 may use these access credentials to carry out an authentication procedure with the gateway device 130 in order to identify itself as a device that is authorized to access the accessory device 110.

Upon receiving the communication interface information from the server device 170, the gateway device 130 initiates operation of the gateway function, thereby enabling access to the accessory device 110 by the terminal device 150 and/or by other (terminal) devices. As another example, the operation of the gateway function may not be initiated automatically in response to reception of the communication interface information but a user of the gateway device 130 may be prompted (e.g. via the user interface of the gateway device 130) to activate or initiate the operation of the gateway function and the operation is initiated in response to a user action in this regard.

Along similar lines, upon receiving the UI information from the server device 170, the terminal device 150 initiates operation of the user interface (e.g. as a GUI component in the user interface of the terminal device 150), thereby enabling the user of the terminal device 150 to start accessing or using the accessory device 110. As another example, the operation of the accessory UI component in the terminal device 150 may not be initiated automatically in response to reception of the accessory UI information but a user of the terminal device 150 may be prompted (e.g. via the user interface of the terminal device 150) to activate or initiate the operation of the accessory UI component and the operation is initiated in response to a user action in this regard.

Once the accessory UI component in the terminal device 150 and the gateway function in the gateway device 130 are operational, the user may start using or accessing the accessory device 110. Since there is no need for the terminal device 150 to directly communicate with the accessory device 110, such use/access of the accessory device 110 may be considered as remote access.

Remote use/access may involve the terminal device 150 receiving, via the accessory UI component, user input that result in commands or requests for the accessory device 110 to carry out a certain operation or action, e.g. to change or adjust a certain characteristic of its operation or to respond by providing a certain piece of information. An example of such procedure is outlined in steps 514 to 520:
In step 514, the terminal device 150 transmits a first request or command to the gateway device 130 in response to user input received via the accessory UI component.
In step 516, the gateway device 130 transmits a further request or command to the accessory device 110. The further request or command is created on basis of the first request or command received from the terminal device 150 and it is transmitted to the accessory device 110 in accordance with the communication interface.
In step 518, the accessory device 110 transmits device data to the gateway device 130 in response to the further request or command received therefrom. The accessory device 110 may obtain the device data to be transmitted to the gateway device e.g. by reading from the memory 115 a piece of device data in accordance with the request of command or by invoking an operation or procedure to obtain the device data in accordance with the request of command.
In step 520, the gateway device 130 transmits the device data received from the accessory device 110 via the communication interface to the terminal device 150 for presentation to the user via the accessory UI component.
Upon reception of the device data from the gateway device 130 as a consequence of step 520, the accessory UI component in the terminal device 150 may cause displaying the device data received from the gateway device 130 or information derived therefrom via the user interface of the terminal device 150.

According to the examples described in context of steps 514 to 520 in the foregoing, the device information destined to or originating from the accessory device 110 is transferred ‘directly’ between the terminal device 150 and the gateway device 130. In practice, though, the commands or requests invoked due to user input via the accessory UI component and/or respective responses from the accessory device 110 are likely transferred between the terminal device 150 and the gateway device 130 through a number of intermediate elements (of the access networks and the computer network employed to connect the two devices), but they are transmitted ‘directly’ from the terminal device 150 to the gateway device 130 or vice versa in the sense that they are addressed from the terminal device 150 to the gateway device 130 or vice versa.

In another example, the commands or requests invoked due to user input via the accessory UI component and/or respective responses from the accessory device 110 are transmitted between the terminal device 150 and the gateway device 130 via the server device 170. In particular, in this example the control information obtained from the user via the accessory UI component is transmitted from the terminal device 150 to the server device 170, which relays the information to the gateway device 130 for further provision to the accessory device 110 via the communication interface. Along similar lines, the gateway device 130 transmits device data received via the communication interface from the accessory device 110 is transmitted to the server device 170, which relays the device data to the terminal device 150 for presentation to the user via the accessory UI component. In this example, it is not necessary for the terminal device 150 to have knowledge regarding the identity of the gateway device 130 and hence the accessibility indication (of step 506) may be transmitted from the server device 170 to the terminal device 150 without including the gateway device identifier therein.

According to an example, the gateway device 130 may limit the access to the accessory device 110 in dependence of known or estimated position of the terminal device 150 with respect to the position of the accessory device 110. For this purpose, the gateway device 130 may determine whether the terminal device 150 is in close proximity to the accessory device 110 and to allow the terminal device 150 to have full access to the accessory device 110 only in response to finding the terminal device 150 to be in close proximity to the accessory device and, conversely, to provide the terminal device 150 with limited access to the accessory device 110 in response to finding the terminal device 150 to not be in close proximity to the accessory device 110. As an example, such limitation may be applied e.g. to disallow any attempt to control or adjust a characteristic of the accessory device 110 via the accessory UI component operated in the terminal device 150 or to disallow one or more predefined aspects of controlling or adjusting a characteristic of the accessory device 110 via the accessory UI component in the terminal device 150, such as any attempt to activate or switch on the accessory device 110 or to activate or switch on a function available in or via the accessory device 110.

As an example regarding the estimation of the position of the terminal device 150 with respect to the position of the accessory device 110, if the gateway device 130 has received the position indication concerning position of the terminal device 150 from the server device 170 in context of provision of the communication interface information or s as subsequent updates concerning the position of the terminal device 150, the gateway device 130 may determine the position of the terminal device 150 in relation to the position of the accessory device 110 by comparing the position of the terminal device 150 so indicated to a reference position. The reference position may be the known or estimated position of the accessory device 110 (indication of which may be have been received from the accessory device 110 or estimated by the gateway device 130, e.g. along the lines described in the foregoing).

As another example concerning the estimation of the position of the terminal device 150 with respect to the position of the accessory device 110, in case the gateway device 130 receives the control information from the terminal device 150 in IP packets, it may obtain a rough estimate of the relative position of the terminal device 150 by comparing the IP address assigned for the terminal device found in the received IP packets to the IP address assigned for the gateway device 130: in case the both IP addresses indicate the same subnet and thus being on the same link, the terminal device 150 may be considered to be in close proximity to the gateway device 130 (and hence also in close proximity to the accessory device 110). In contrast, IP addressed that indicate different subnets may considered to serve as an indication of the terminal device 150 not being in close proximity to the gateway device 130 (and the accessory device 110).

The terminal Switching to Remote Access if Local Access Fails

According to a further example, the terminal device 150 may have itself previously discovered the accessory device 110 by using the wireless communication portion 152a and obtained both a user interface and a communication interface that enable the terminal 150 that enable the terminal device 150 to directly use or access the accessory device 110 via the wireless communication portion 152a. Consequently, the terminal device 150 may subsequently, in response to a user action, carry out a device discovery procedure in an attempt to discover the accessory device 110 and, if successful, to attempt to directly access or use the accessory device 110 using the previously obtained user interface and the communication interface. If the use/access is successful, no further actions are needed to enable the terminal device 150 using/accessing the accessory device 110. In contrast, in case either the device discovery or the use/access turns out unsuccessful, the terminal device 150 may proceed to request an accessory UI that enables access to the accessory device 110 via a gateway device. This may be provided by proceeding from step 508 described in the foregoing, i.e. by sending the access request to the server device 170 in order to receive the accessory UI information that enables the remote access to the accessory device 110 via the gateway device 130.

In case the server device 170 receives updates of the current position of the terminal device 150 after reception of the access request, the server device 170 may re-select the accessory UI information for (and hence the accessory UI component to be provided in) the terminal device 150 on basis of the changed position of the terminal device 150 with respect to the accessory device 110. As an example, if the terminal device 150 has been provided with the first accessory UI information due to being in close proximity to the accessory device 110 but the updated position indication(s) indicate that the terminal device 150 is no longer in close proximity to the accessory device 110, the server device 170 may transmit the second accessory UI information to the terminal device 150 and the terminal device starts using the accessory UI component defined by the newly received accessory UI information instead of the one applied earlier. In contrast, if the terminal device 150 has been provided with the second accessory UI information due to not being in close proximity to the accessory device 110 but the updated position indication(s) indicate that the terminal device 150 is now in close proximity to the accessory device 110, the server device 170 may transmit the first accessory UI information to the terminal device 150 and the terminal device 150 replaces the currently applied accessory UI component with the one defined by the newly received accessory UI information.

As already briefly described in the foregoing, instead of providing the communication interface information that defines the communication interface for accessing the accessory device 110 as program code, the communication interface information may, alternatively, specify rules, instructions, configurations, parameters or attribute values of a predefined communication framework such that it implements the communication interface that enables providing the control information to the accessory device 110 and receiving device data from the accessory device 110 as desired. As an example, in context of BLE communication between the gateway device 130 and the accessory device such communication framework may be provided in context of the GATT. Such an approach is likely to provide a more lightweight solution (in terms of processing power required in the gateway device 130 and/or in terms of information transferred from the server device 170 to the gateway device 150 upon initializing the gateway function) than the one relying on a communication interface provided as program code, while on the other hand such an approach may not be well suited in control of complex accessory devices.

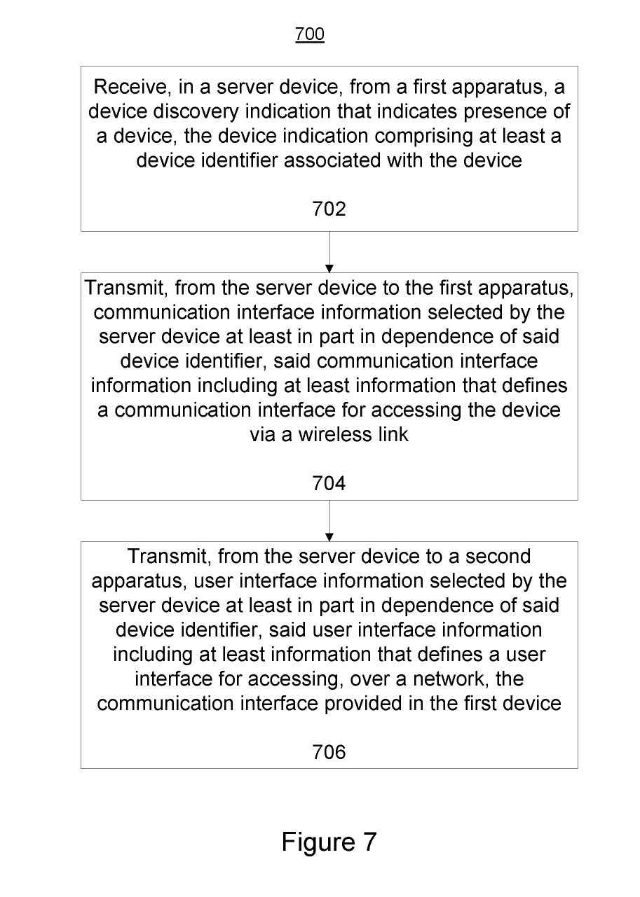

While the above description of the signaling chart of FIG. 6 and the related operation of components of the wireless communication arrangement 100 describes the overall operation of arrangement 100 and also provides a number of non-limiting examples concerning various details of the operation, in the following further exemplifying methods are described with references to FIGS. 7 to 9 to outline the operations in viewpoint of the server device 170, the gateway device 130 and the terminal device, respectively.

FIG. 7 depicts a flowchart that outlines a method 700 according to an example embodiment of the invention. The method 700 comprises receiving, in the server device 170, from the gateway apparatus 130, the device discovery indication that indicates presence of the accessory device 110, the device indication comprising at least the accessory device identifier associated with the accessory device 110, as indicated in block 702.

The method 700 further comprises transmitting, from the server device 170 to the gateway device 130, communication interface information selected by the server device 170 at least in part in dependence of the device identifier, the communication interface information including at least information that defines a communication interface for accessing the accessory device via a wireless link, as indicated in block 704.

The method 700 further comprises transmitting, from the server device 170 to the terminal device 150, user interface information selected by the server device 170 at least in part in dependence of the device identifier, the user interface information including at least information that defines a user interface for accessing, over the computer network, the communication interface provided in the gateway device 130, as indicated in block 706.

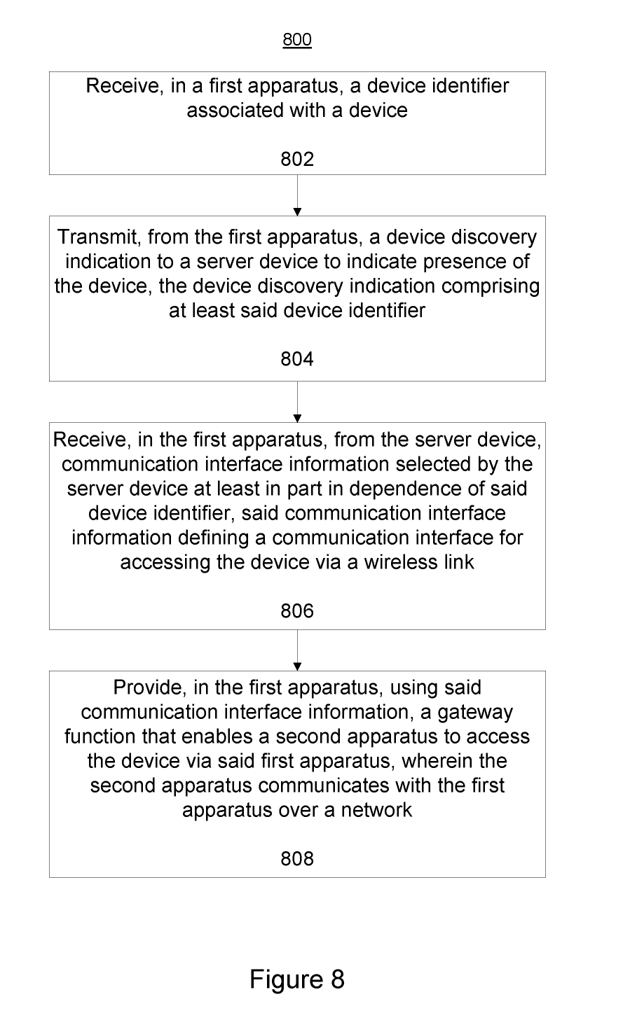

FIG. 8 depicts a flowchart that outlines a method 800 according to an example embodiment of the invention. The method 800 comprises receiving, in the gateway device 130, the device identifier associated with the accessory device 110, as indicated in block 802. The method 800 further comprises transmitting, from the gateway device 130, the device discovery indication to the server device 170 to indicate presence of the accessory device 110, the device discovery indication comprising at least the device identifier, as indicated in block 804.

The method 800 further comprises receiving, in the gateway device 130, from the server device 170, communication interface information selected by the server device 170 at least in part in dependence of the device identifier, the communication interface information defining a communication interface for accessing the accessory device 110 via a wireless link, as indicated in block 806.

The method 800 further comprises providing, in the gateway device 130, using the communication interface information, a gateway function that enables the terminal device 150 to access the accessory device 110 via the gateway device 130, wherein the terminal device 150 communicates with the gateway device 130 over a computer network, as indicated in block 808.

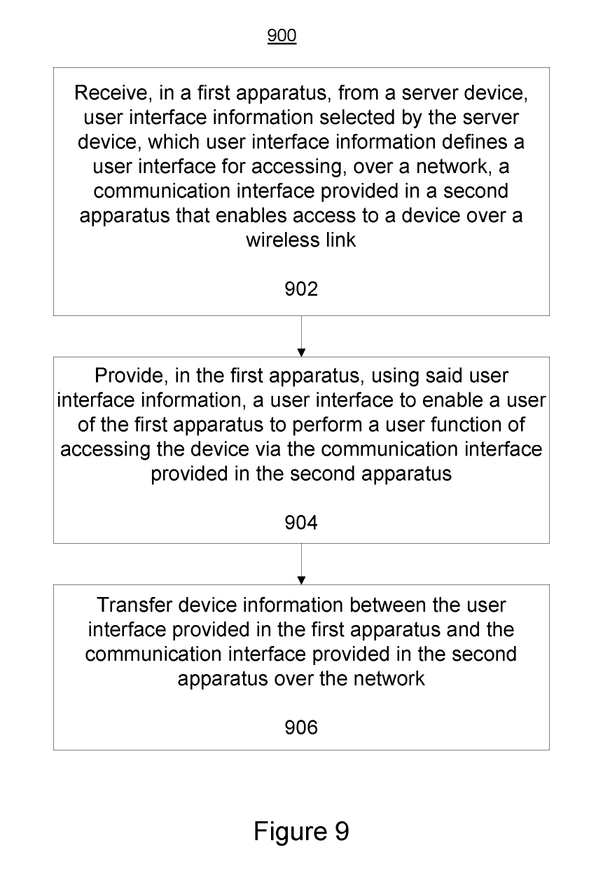

FIG. 9 depicts a flowchart that outlines a method 900 according to an example embodiment of the invention. The method 900 comprises receiving, in the terminal device 150, from the server device 170, user interface information selected by the server device 170, which user interface information defines a user interface for accessing, over a computer network, a communication interface provided in the gateway device 130 that enables access to the accessory device 110 over a wireless link, as indicated in block 902.

The method 900 further comprises providing, in the terminal device 150, using the user interface information, a user interface to enable a user of the terminal device 150 to perform a user function of accessing the accessory device 110 via the communication interface provided in the gateway device 130, as indicated in block 904.

The method 900 further comprises transferring device information between the user interface provided in the terminal device 150 and the communication interface provided in the gateway device 130 over the computer network, as indicated in block 906.

Each of the methods 700, 800 and 900 may be further varied in a number of ways, e.g. in accordance with the description of the operation of the wireless communication arrangement 100 provided in the foregoing.

Referring back to components of the accessory device 110, the gateway device 130, the terminal device 150 and the server device 170, the processor 116, 136, 156, 176 is configured to read from and write to the respective memory 115, 135, 155, 175. Although each of the processors 116, 136, 156, 176 is depicted as a respective single component, any of the processors 116, 136, 156, 176 may be implemented as respective one or more separate processing components. Similarly, although each of the memories 115, 135, 155, 175 is depicted as a respective single component, any of the memories 115, 135, 155, 175 may be implemented as respective one or more separate components, some or all of which may be integrated/removable and/or may provide permanent/semi-permanent/dynamic/cached storage.

The memory 115, 135, 155, 175 may store the respective computer program 117, 137, 157, 177 comprising computer-executable instructions that control the operation of the respective device 110, 130, 150, 170 when loaded into the respective processor 116, 136, 156, 176. As an example, the computer program 137 may include one or more sequences of one or more instructions. The computer program 137 may be provided as a computer program code. The processor 136 is able to load and execute the computer program 137 by reading the one or more sequences of one or more instructions included therein from the memory 135. The one or more sequences of one or more instructions may be configured to, when executed by the processor 136, cause the gateway device 130 to carry out operations, procedures and/or functions described in the foregoing in context of the wireless communication arrangement 100. Hence, the gateway device 130 may comprise at least one processor 136 and at least one memory 135 including computer program code for one or more programs, the at least one memory 135 and the computer program code configured to, with the at least one processor 136, cause the gateway device 130 to perform operations, procedures and/or functions described in the foregoing in context of the gateway device 130. Similar considerations are equally valid for corresponding components 11x of the accessory device 110, for corresponding components 15x of the terminal device 150 and for corresponding components 17x of the server device 170.

Each of the computer programs 117, 137, 157, 177 may be provided e.g. as a respective computer program product comprising at least one computer-readable non-transitory medium having program code stored thereon, the program code, when executed by the respective device 110, 130, 150, 170, causes the apparatus 110, 130, 150, 170 at least to perform operations, procedures and/or functions described in the foregoing in context of the respective device 110, 130, 150, 170 in description of operation of the wireless communication arrangement 100. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

Misc Generic Remarks

Although functions have been described with reference to certain features, those functions may be performable by other features whether described or not. Although features have been described with reference to certain embodiments, those features may also be present in other embodiments whether described or not.

1. A method comprising
receiving, in a first apparatus, from a device over a wireless link, a device identifier associated with the device;
transmitting, from the first apparatus over a network to a server device, a device discovery indication to indicate presence of the device, the device discovery indication comprising at least said device identifier;
receiving, in the first apparatus, from the server device, communication interface information selected by the server device at least in part in dependence of said device identifier, said communication interface information defining a communication interface for accessing the device via the wireless link; and,
providing, in the first apparatus, using said communication interface information, a gateway function that enables a second apparatus to access the device via said first apparatus, wherein the first apparatus is able to communicate with the second apparatus over the network.

2. A method according to claim 1, wherein receiving the device identifier comprises receiving, from the device over the wireless link, one or more device discovery messages that include the device identifier,
wherein the method further comprises deriving, in the first apparatus, a received signal strength indicator, RSSI, that is descriptive of the signal strength of said one or more device discovery messages and detecting, in the first apparatus, based at least in part of the derived RSSI, whether the first apparatus is in close proximity to the device; and
wherein transmitting the device discovery indication comprises transmitting the device discovery indication in response to detecting that the first apparatus is in close proximity to the device.

3. A method according to claim 1 or 2, wherein said wireless link comprises a wireless link according to the Bluetooth Low Energy standard.

4. A method according to any of claims 1 to 3, wherein providing the gateway function comprises transferring device information between a user interface provided in the second apparatus and the device, comprising at least one of
transferring device data received from the device over the wireless link via the communication interface over the network to the second apparatus, and
transferring control information received over the network from the second apparatus to the device over the first wireless link via the communication interface.

5. A method according to claim 4, wherein said communication interface information further defines one or more conversion procedures for converting the device information from one format to another, comprising at least one of the following:
one or more conversion procedures for converting device data received via the communication interface into a format suitable for provision to the user interface, and
one or more conversion procedures for converting control information received from the user interface into a format suitable for provision via the communication interface.

6. A method according to any of claims 1 to 5, further comprising
determining, in the first apparatus, whether the second apparatus is in close proximity to the device,
operating the gateway function to provide a full access to the device via the communication interface in response to detecting that the second apparatus is in close proximity to the device, and
operating the gateway function to provide a limited access to the device via the communication interface in response to detecting that the second apparatus is not in close proximity to the device.

7. A method comprising
receiving, in a first apparatus, from a server device, user interface information selected by the server device, which user interface information defines a user interface for accessing, over a network, a communication interface provided in a second apparatus that enables access to a device over a wireless link;
providing, in the first apparatus, using said user interface information, a user interface to enable a user of the first apparatus to perform a user function of accessing the device via the communication interface provided in the second apparatus; and
transferring, over the network, device information between the user interface provided in the first apparatus and the communication interface provided in the second apparatus.

8. A method according to claim 7, wherein the device information comprises at least one of device data originating from the device and control information destined to the device, and wherein transferring device information comprises at least one of
receiving, in the first apparatus, device data from the communication interface over the network and presenting the received device data to a user via the user interface in the first apparatus, and
obtaining, in the first apparatus, control information from the user via the user interface and transmitting, from the first apparatus, the obtained control information over the network to the communication interface.

9. A method according to claim 7 or 8, further comprising
obtaining, in the first apparatus, a position indication that indicates the current position of the first apparatus; and
transmitting the obtained position indication to the server device for selection of the user interface information for the first apparatus in the server device at least in part in dependence of the current position of the first apparatus.

10. A method according to any of claims 7 to 9, further comprising,
receiving, in the first apparatus, a device indication concerning the device being accessible via the communication interface provided in the second apparatus, the device indication comprising at least a device identifier associated with the device;
transmitting, to the server device, in response to the device indication, an access request for accessing the device; and
receiving, in the first apparatus, the user interface information from the server device in response the access request.

11. A method according to any of claims 7 to 9, further comprising
transmitting, from the first apparatus to the server device, in response to a failure to directly access the device via a wireless link, an access request for accessing the device via the second apparatus; and
receiving, in the first apparatus, the user interface information from the server device in response the access request.

12. A method according to claim 10 or 11, wherein said access request comprises a device type identifier assigned for the apparatus, which device type identifier is useable for selection of the user interface information for the apparatus in the server device at least in part in dependence of said device type identifier.

13. A method comprising
receiving, in a server device, from a first apparatus, a device discovery indication that indicates presence of a device, the device indication comprising at least a device identifier associated with the device;
transmitting, from the server device to the first apparatus, communication interface information selected by the server device at least in part in dependence of said device identifier, said communication interface information including at least information that defines a communication interface for accessing the device via a wireless link; and
transmitting, from the server device to a second apparatus, user interface information selected by the server device at least in part in dependence of said device identifier, said user interface information including at least information that defines a user interface for accessing, over a network, the communication interface provided in the first apparatus.

14. A method according claim 13, further comprising
receiving, in the server device from the second apparatus, an access request for accessing the device; and
transmitting the communication interface information and the user interface information from the server device in response to the access request.

15. A method according to claim 13 or 14, further comprising
obtaining, in the server device, a first position indication that indicates the current position of the second device and a reference position indication that indicates position of the device; and
selecting the user interface information at least in part in dependence of the current position of the second device in relation to the position of the device.

16. A method according to claim 15, wherein
obtaining the first position indication comprises receiving a position indication from the second apparatus; and
obtaining the reference position indication comprises receiving a position indication from the first apparatus.

17. A method according to claim 15 or 16, wherein selecting the user interface information comprises
determining, in the server device, whether the second apparatus is in close proximity to the device;
selecting, in response to detecting that the second apparatus is in close proximity to the device, first user interface information that defines a first user interface, and
selecting, in response to detecting that the second apparatus is not in close proximity to the device second user interface information that defines a second user interface,
wherein the second user interface information defines a user interface different from that defined by the first user interface information.

18. A method according to any of claims 12 to 17, further comprising
obtaining a device type identifier assigned for the second device; and
selecting the user interface information at least in part in dependence of said device type identifier.

19. A method according to any of claims 1 to 18, wherein accessing the device comprises at least one of the following:
transmitting, to the device, control information for one of requesting device data from the device and controlling a characteristic of the device, and
receiving, from the device, device data available therein.

20. A computer program comprising computer readable program code configured to cause performing of the method of any of claims 1 to 19 when said program code is run on a computing apparatus.

21. A computer program product comprising at least one computer readable non-transitory medium having program code stored thereon, the program code, when executed by an apparatus, causing the apparatus at least to perform the method of any of claims 1 to 19.

22. An apparatus comprising
a communication portion comprising at least
a first communication apparatus for wireless communication with other apparatuses over a wireless link, and
a second communication apparatus for one of wired and wireless communication with other apparatuses over a network; and
a control portion arranged to
receive, from a device, using said first communication apparatus, a device identifier associated with the device;
transmit, to a server device, using said second communication apparatus, a device discovery indication to indicate presence of the device, the device discovery indication comprising at least said device identifier;
receive, from the server, using said second communication apparatus, communication interface information selected by the server device at least in part in dependence of said device identifier, said communication interface information defining a communication interface for accessing the device using said first communication apparatus; and,
provide, using said communication interface information, a gateway function that enables a second apparatus to access the device via the apparatus, wherein the control portion is arranged to communicate with the second apparatus using the second communication apparatus.

23. An apparatus according to claim 22, wherein receiving the device identifier comprises receiving, from the device, using said first communication apparatus, one or more device discovery messages that include the device identifier, wherein the control portion is arranged to derive a received signal strength indicator, RSSI, that is descriptive of the signal strength of said one or more device discovery messages and to detect, based at least in part of the derived RSSI, whether the first apparatus is in close proximity to the device; and
wherein transmitting the device discovery indication comprises transmitting the device indication in response to detecting that the apparatus is in close proximity to the device.

24. An apparatus according to claim 22 or 23, wherein said first communication apparatus is arranged to communicate with other apparatuses using the Bluetooth Low Energy standard.

25. An apparatus according to any of claims 22 to 24, wherein providing the gateway function comprises transferring device information between a user interface provided in the second apparatus and the device, comprising the control portion configured to at least one of
transfer device data received from the device via the communication interface to the second apparatus, and
transfer control information received from the second apparatus to the device via the communication interface.

26. An apparatus according to claim 25, wherein said communication interface information further defines one or more conversion procedures for converting the device information from one format to another, comprising at least one of the following:
one or more conversion procedures for converting device data received via the communication interface into a format suitable for provision to the user interface, and
one or more conversion procedures for converting control information received from the user interface s into a format suitable for provision via the communication interface.

27. An apparatus according to any of claims 22 to 26, wherein the control portion is arranged to
determine whether the second apparatus is in close proximity to the device,
operate the gateway function to provide a full access to the device via the communication interface in response to detecting that the second apparatus is in close proximity to the device, and
operate the gateway function to provide a limited access to the device via the communication interface in response to detecting that the second apparatus is not in close proximity to the device.

28. An apparatus comprising
a communication portion comprising at least a communication apparatus for one of wired and wireless communication with other apparatuses over a network; and
a control portion arranged to
receive, from a server device, using said communication apparatus, user interface information selected by the server device, which user interface information defines a user interface for accessing, using said communication apparatus, a communication interface provided in a second apparatus that enables access to a device over a wireless link;
provide, using said user interface information, a user interface to enable a user of the apparatus to perform a user function of accessing the device via the communication interface provided in the second apparatus; and
transfer, using said communication apparatus, device information between the user interface provided in the apparatus and the communication interface provided in the second apparatus

29. An apparatus according to claim 28, wherein the device information comprises at least one of device data originating from the device and control information destined to the device, and wherein transferring device information comprises at least one of
receiving device data from the communication interface and presenting the received device data to a user via said user interface, and
obtaining control information from the user via the user interface and transmitting the obtained control information to the communication interface.

30. An apparatus according to claim 28 or 29, wherein the control portion is arranged to
obtain a position indication that indicates the current position of the apparatus; and
transmit the obtained position indication to the server device for selection of the user interface information for the apparatus in the server device at least in part in dependence of the current position of the apparatus.

31. An apparatus according to any of claims 28 to 30, wherein the control portion is arranged to
receive, using said communication apparatus, a device indication concerning the device being accessible via the communication interface provided in the second apparatus, the device indication comprising at least a device identifier associated with the device;
transmit, to the server device, in response to the device indication, an access request for accessing the device; and
receive the user interface information from the server device in response the access request.

32. An apparatus according to any of claims 28 to 30, wherein the control portion is arranged to
transmit, to the server device, using said communication apparatus, in response to a failure to directly access the device via a wireless link, an access request for accessing the device via the second apparatus; and
receive the user interface information from the server device in response the access request.

33. An apparatus according to claim 31 or 32, wherein said access request comprises a device type identifier assigned for the apparatus, which device type identifier is useable for selection of the user interface information for the apparatus in the server device at least in part in dependence of said device type identifier.

34. An apparatus comprising
a communication portion comprising at least a communication apparatus for one of wired and wireless communication with other apparatuses over a network; and
a control portion arranged to use the communication apparatus to
receive, from a first apparatus, a device discovery indication that indicates presence of a device, the device indication comprising at least a device identifier associated with the device;
transmit, to the first apparatus, communication interface information selected in the apparatus at least in part in dependence of said device identifier, said communication interface information including at least information that defines a communication interface for accessing the device via a wireless link; and
transmit, to a second apparatus, user interface information selected in the apparatus at least in part in dependence of said device identifier, said user interface information including at least information that defines a user interface for accessing, over a network, the communication interface provided in the first apparatus.

35. An apparatus according claim 34, wherein the control portion is arranged to use said communication apparatus to
receive, from the second apparatus, an access request for accessing the device; and
transmit the communication interface information and the user interface information from the server device in response to the access request.

36. An apparatus according to claim 34 or 35, wherein the control portion is arranged to
obtain a first position indication that indicates the current position of the second device and a reference position indication that indicates position of the device; and
select the user interface information at least in part in dependence of the current position of the second device in relation to the position of the device.

37. An apparatus according to claim 36, wherein
obtaining the first position indication comprises receiving a position indication from the second apparatus; and
obtaining the reference position indication comprises receiving a position indication from the first apparatus.

38. An apparatus according to claim 36 or 37, wherein selecting the user interface information comprises
determining whether the second apparatus is in close proximity to the device;
selecting, in response to detecting that the second apparatus is in close proximity to the device, first user interface information that defines a first user interface, and
selecting, in response to detecting that the second apparatus is not in close proximity to the device second user interface information that defines a second user interface,
wherein the second user interface information defines a user interface different from that defined by the first user interface information.

39. An apparatus according to any of claims 34 to 38, wherein the control portion is arranged to
obtain a device type identifier assigned for the second device; and
select the user interface information at least in part in dependence of said device type identifier.

40. An apparatus according to any of claims 22 to 39, wherein accessing the device comprises at least one of the following:
transmitting, to the device, control information for one of requesting device data from the device and controlling a characteristic of the device, and
receiving, from the device, device data available therein.

41. An apparatus comprising
means for receiving, from a device, over a wireless link, a device identifier associated with the device;
means for transmitting, over a network to a server device, a device discovery indication to indicate presence of the device, the device discovery indication comprising at least said device identifier;
means for receiving, from the server device, communication interface information selected by the server device at least in part in dependence of said device identifier, said communication interface information defining a communication interface for accessing the device via the wireless link; and,
means for providing, in the apparatus, using said communication interface information, a gateway function that enables a second apparatus to access the device via the apparatus, wherein the apparatus is able to communicate with the second apparatus over the network.

42. An apparatus comprising
means for receiving, from a server device, user interface information selected by the server device, which user interface information defines a user interface for accessing, over a network, a communication interface provided in a second apparatus that enables access to a device over a wireless link;
means for providing, in the apparatus, using said user interface information, a user interface to enable a user of the apparatus to perform a user function of accessing the device via the communication interface provided in the second apparatus; and
means for transferring, over the network, device information between the user interface provided in the apparatus and the communication interface provided in the second apparatus.

43. An apparatus comprising
means for receiving, from a first apparatus, a device discovery indication that indicates presence of a device, the device indication comprising at least a device identifier associated with the device;
means for transmitting, to the first apparatus, communication interface information selected in the apparatus at least in part in dependence of said device identifier, said communication interface information including at least information that defines a communication interface for accessing the device via a wireless link; and
means for transmitting, to a second apparatus, user interface information selected in the apparatus at least in part in dependence of said device identifier, said user interface information including at least information that defines a user interface for accessing, over a network, the communication interface provided in the first apparatus.
